(19) United States
(12) Patent Application Publication
(10) Pub. No.: US 2002/0046898 A1
(43) Pub. Date: Apr. 25, 2002

(54) STEERING ARRANGEMENT

(76) Inventors: JESPER OLSEN BLOCH, NORDBORG (DK); JOHN KRISTENSEN, SONDERBORG (DK); JOHN BORSTING JENSEN, NORDBORG (DK)

Correspondence Address: LEE MANN SMITH MCWILLIAMS, SWEENEY & OHLSON, PO BOX 2786, CHICAGO, IL, 606902786

(21) Appl. No.: 09/381,570

(22) PCT Filed: Apr. 6, 1998
(86) PCT No.: PCT/DK98/00140

(30) Foreign Application Priority Data
Apr. 10, 1997 (DE) 19714786.0

(51) Int. Cl. B62D 5/04

(52) U.S. Cl. 180/446; 180/443

(57) ABSTRACT

The invention concerns a steering arrangement (1) with a steering angle indicator (2), a steering drive (4), at least one wheel (5) driven by the steering drive (4), a sensor arrangement for sensing the angle position of the wheel (5) and a control device (14). To simplify mouting and maintenance, the embodiment of such steering arrangements must be simple. For this purpose the sensor arrangement has a first acquisition device (15, 16) sensing the extend of a movement of the steering drive (4) relative to a starting position and being integrated in the steering drive (4), and a second acquisition device (17, 18) producing a reference signal for at least one position of the steering drive (4)

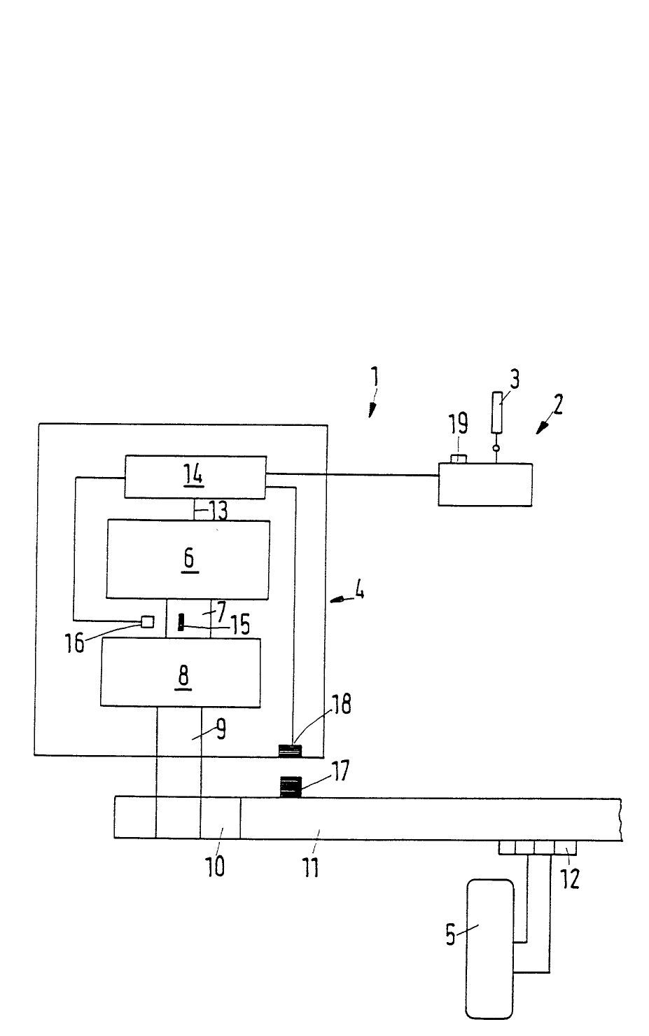

The invention concerns a steering arrangement with a steering angle indicator, a steering drive, at least one wheel driven by the steering drive, a sensor arrangement sensing the angle position of the wheel and a control device.

Such steering arrangements are often required when a mechanical connection, for instance a steering handwheel, is not available between the steered wheel and the steering angle indicator. In this case the driver sets the wanted steering angle of the wheel(s) via the steering angle indicator. The steering drive then moves the wheel to the wanted position. When a three-wheel vehicle is used, which is for instance often the case with fork trucks, one wheel is steered. When four- or multi-wheel vehicles are used, normally two wheels are steered in pairs. To simplify the description, the following will only concern one steered wheel.

To enable the steering arrangement to check if the steered wheel has assumed the wanted angle position, this angle position is monitored by means of a sensor. The angle position is then reported back to the control device which compares the determined actual value with the pre-set desired value and, if required, repositions the wheel.

In such a steering arrangement it is, however, a disadvantage that the sensor must be arranged close to the steered wheel to be able to determine the position. The further the sensor is away from the steered wheel, that is, the further the indicating and receiving parts of the sensor are apart from each other, the larger will the inaccuracies and thus the errors when determining the steering angle be. Therefore, more accurate sensors must used, which make the steering arrangements more expensive. Additionally, a more complicated wiring is often required, as the sensor control device and the sensor or the steering drive are farther apart. The larger distance and the transmission cables involved do not only increase the cost of assembling. They are also a source of errors, as the longer cables are more easily interrupted.

The task of the invention is to make a more simple construction of a steering arrangement.

In a steering arrangement as mentioned in the introduction this task is solved in that the sensor arrangement has a first acquisition device sensing the extent of a movement of the steering drive relative to a starting position and being integrated in the steering drive, and a second acquisition device producing a reference signal for at least one position of the steering drive.

This means that the sensor arrangement is split into two function units. One function unit, namely the first acquisition device senses the relative movement effected by the steering drive when moving the wheel. However, it is far more simple to determine a relative movement than to determine the absolute position. The first acquisition device can therefore be of a much simpler construction. However, it can also be integrated in the steering drive, meaning that the cables are short. This simplifies fitting and maintenance. However, the sensor arrangement needs information about the starting point from which the steering movement must be measured, in order that a co-ordination between the absolute position of the steered wheel and the control order given by the steering angle indicator is possible. For this purpose it is sufficient to determine the absolute position of the steered wheel for one single condition. Of course, several such positions can be determined. When merely one or a few positions must be sensed accurately, this can be done in a simple way. The exact angle position of the steered wheel can be calculated currently from the combination of relative movement and absolute position.

In this connection it is an advantage if the second acquisition device has an indicator arranged at a transmission element of the steering drive and a detector co-operating with the indicator. When the indicator passes the detector, the detector can produce the required reference signal. As the detector only produces this signal when it is passed by the indicator or when the indicator assumes a corresponding position in relation to the detector, an accurate determination of the position of the steered wheel at that moment is possible with little effort. The transmission element is arranged between the steering drive and the steered wheel. Thus, the detector can be positioned relatively close to the steering drive, meaning that also here no long cables are required. Of course the detector can also be completely integrated in the steering drive.

Preferably, the transmission element is a chain, a toothed belt or a toothed gear. Thus, the indicator must simply be fixed on the chain, the toothed belt or the toothed gear to produce reference signal in the wanted positions of the steered wheel. The indicator can, for instance, be a magnet co-operating with a Reed relay. The indicator can also be a cam actuating a switch. Possible are also light barrier constructions or other combinations of elements, which in a certain position of the chain, the belt or the toothed gear, cause a change of the detector environment so that the detector produces the reference signal. Between the chain, the toothed belt or the toothed gear, respectively, and the angle position of the steered wheel there is a unique correlation, that is, each position of the steered wheel corresponds exactly to one position of the chain, the toothed belt or the toothed gear and thus of the indicator. This enables a reliable indication of the angle position of the steered wheel.

Advantageously, the steering drive has a rotary motor and the first acquisition device senses a rotation angle of the motor. This is a relatively simple procedure. The rotation angle of the motor, or more accurately, the rotation angle of the rotor in the motor, is easily detectable by known methods and components.

It is particularly preferred that the first acquisition device senses the number of revolutions of the motor. A finer resolution is often not required. The number of revolutions can be established by simple counting.

It is particularly preferred that the steering drive has a transmission gear and the sensor arrangement has a calculation device multiplying the number of revolutions of the motor by a value depending on the gear transmission ratio. In most cases a transmission gear is available, in order that the motor can be dimensioned with a lower torque. Consequently, the motor must perform a larger number of revolutions to steer the wheel. This combination now advantageously ends up with the fact that the number of revolutions of the motor is counted. By means of the transmission gear a resolution occurs, which is fine enough to enable determination of the angle position of the steered wheel with the required accuracy. The gear transmission ratio is then known. It is known that one revolution of the motor corresponds to a predetermined angle change of the steered wheel. This can also be evaluated through a multiplication in the control unit.

Preferably, the first acquisition device has a sensor built into a motor bearing. Such sensors for building into motor bearings are for example made by the company SKF. Building the sensors into the motor bearing saves space and keeps the cables short.

In an alternative or additional embodiment the motor is an a.c. or a three-phase motor supplied by a frequency converter, the first acquisition device evaluating the supply voltage of the motor. In such motors the number of electric periods can be directly converted into the number of revolutions of the motor. In a two-pole motor the number of periods corresponds to the number of revolutions. In multi-pole machines the number of periods must be divided by the number of pole pairs to find the number of revolutions of the rotor. Thus an additional sensor can be avoided. The information about the electrical voltage of the motor is available anyway. This can be evaluated electrically, so that the steering arrangement can be made in a relatively simple and inexpensive way. D.c. motors, switched reluctance motors, step motors or permanent motors can also be used, if their supply voltage contains the corresponding impulses.

Advantageously, the first acquisition device counts impulses supplied to the motor by the frequency converter. Thus, the first acquisition device no longer has to track the complete voltage course. It is sufficient for the sensor arrangement to count, for example, how often the supply voltage exceeds a certain threshold value. In many cases the frequency converter no longer supplies a purely sinusoidal voltage to the motor anyway, but supplies the motor with an approximately impulse shaped supply voltage, in order that an additional impulse shaping can be avoided.

Advantageously, the control device has a transmission characteristic, which depends on the operation speed of the steering angle indicator. The isolation of the steering angle indicator and the steered wheel causes that steering philosophies can now be followed, which no longer correspond to a unique correlation between the position of the steering angle indicator, that is, the pre-set rated value, and the actual value of the steered wheel, but follow different rules. For instance, a slow movement of the steering angle indicator can realise a high resolution, that is a slow movement of the steered wheel, the desired angle position being assumed with a high degree of accuracy. On the other hand, a fast movement of the steering angle indicator will give a correspondingly fast movement of the steered wheel, the final position being assumed with a lower degree of accuracy.

Alternatively or additionally, the control device may have a transmission characteristic which depends on the driving speed of the steered vehicle. When driving at low speed, other deflections of the steering angle indicator are required to effect the desired change of direction.

Advantageously, the control device has a straight ahead function. Thus the operator can give an order, for instance press a button, which will make the control device move the steering drive until the steered wheel is in a straight ahead driving position. In most cases, only very experienced drivers will be able to reach such a position without such auxiliary means. The additional function will make the vehicle easier to handle, also for inexperienced drivers.

Advantageously, the steering angle indicator has a reset drive. When using a steering handwheel, this will enable a self-straightening of the steering handwheel like in a car, in which the steering handwheel returns to the neutral position when released. In a car, however, the resetting forces are exerted by the wheels, which are mechanically connected with the steering handwheel in some way. If this connection is not available, the resetting can normally not take place. Thus, the reset drive is a simple means for improving the operation comfort.

In a particularly preferred embodiment it is provided that the control device has an end stop monitoring arrangement sensing the end position of the steered wheel, and a limiter limiting the movements of the wheel to a predetermined angle range ending at a certain distance from the end positions. When, during operation, the wheel is steered so much to one side that it reaches a mechanical stop, this will often cause an unpleasant impact on the vehicle. When using the steering arrangement in a fork truck this impact may be so strong that goods stacked on pallets start sliding. When now the mechanical stop, that is the position in which mechanical means prevent the steered wheel from mowing on, is detected and the moving of the wheel is limited so that this stop is no longer reached, these impacts are prevented, which does, in a simple way, increase the operation comfort and the operation safety of the steered vehicle. This is possible, even though the absolute position of the wheel is no longer directly detected, but merely the relative movement of the wheel in relation to a starting position. As stated above, this permits a new balancing for each position, if the second acquisition device produces the reference signal on a movement of the steering drive.

In this connection it is particularly preferred that the end stop monitoring arrangement monitors the motor current. When the steered wheel reaches the mechanical stop, the torque to be produced by the motor is increased. However, in the case of electric motors, the current required by the motor often depends on the torque. When the current increases, this is a sign that there is also a higher counter-torque. Thus, this is a relatively unique indication for the reaching of the mechanical stop. It is relatively simple to monitor the motor current.

Advantageously, a starting signal or the putting into operation will make the control device move the steered wheel for so long that the second acquisition device emits a sensing signal. Thus, it is no longer required for the control device to store continuously, that is, also when the vehicle is not working, the absolute position, which is determined on the basis of the relative movement and a known position. On start of operation or from time to time, when the operator produces the corresponding starting signal, it is even possible to make a renewed balancing, so that the required information is available. Of course it cannot be prevented that during operation a deviation occurs between the calculated values and the actual angle position of the steered wheel. As balancing can, however, be made continuously during operation, the fault probability is relatively low.

It is particularly preferred that the control device moves the steered wheel in both directions until stop. This ensures that the reference signal is produced in any case. Further, this embodiment provides that the end positions of the steered wheel can be determined simultaneously, thus limiting the steering area.

Preferably, the second acquisition device produces the reference signal in the area of the straight ahead position of the wheel. During operation most steering movements of the wheel will occur in the area of the straight ahead position. Thus the balancing will most frequently be possible in this position.

In the following the invention is explained on the basis of a preferred embodiment in connection with the drawing showing:

only FIGURE a schematic view of a steering arrangement

A steering arrangement 1 has a steering angle indicator 2, in this case made as control column 3 or “joy-stick”. However, it can also be made as a common steering handwheel.

Further, the steering arrangement 1 has a steering drive 4 by means of which the angle position of a schematically shown steered wheel 5 can be changed. There is, in this case, no mechanically active connection between the steering angle indicator 2 and the steered wheel.

The steering drive has a motor 6, whose output shaft 7 is connected with a gear 8, which transmits the speed of the motor 6. Accordingly, an output shaft 9 of the gear 8 has a considerably lower speed than the output shaft 7 of the motor 6. The output shaft 9 of the gear 8 is connected with a gear wheel 10, which is actively connected via a chain 11 with a gear wheel 12, which again operates the wheel 5. Instead of a chain, a toothed belt or another kind of transmission link can be used, as long as it is ensured that each position of the chain 11 corresponds to a unique position of the wheel 5, that is, a unique steering angle.

The motor 6 is controlled by a control device 14 which supplies the motor 6 with electrical energy via a schematically shown cable 13. Accordingly, the motor 6 is made as an electric motor, for instance, an alternating or a three-phase current motor. Correspondingly, the control device 14 also has a frequency converter, which converts direct current into a one-phase or multi-phase alternating current, or converts the frequency of a one-phase or multi-phase alternating current into a different frequency.

At the same time the control device 14 ensures that the steering angle of the wheel 5, that is, the actual value, corresponds to a steering angle pre-set by the steering angle indicator 2, that is, the rated value. In this connection, it is necessary for the control device to know the actual position of the wheel 5. For this purpose the control device 14 is connected with or has a sensor arrangement, which is explained in the following.

Firstly, the sensor arrangement has a first acquisition device sensing a relative movement of the wheel 5 between two positions. However, this sensing is indirect, that is, not on the wheel itself, but in the steering drive 4. For the purpose of clarification, the motor shaft 7 bears a marking 15, which can be sensed by a sensor 16. Each passing by the sensor 16 of the marking 15 is reported to the control device 14, which can determine the number of motor revolutions accordingly. As the gear ratio of the gear 8 and the correlation between one revolution of the output shaft 9 of the gear 8 and an angle change of the wheel 5 is known, the information obtained from the marking 15 permits a reliable statement of the angle with which the wheel 5 has been turned on a corresponding movement of the motor 6.

Instead of the presented combination of marking 15 and sensor 16, a more simple embodiment provides that the control device 14 counts the impulses received by the motor 6. In the case of frequency controlled electric motors, this is also a unique information about the number of revolutions effected. A sensor built into the motor bearing can also be used. In all cases, however, it is provided that the first acquisition device is placed in the steering drive 4 and is made as a relative sensor unit, so that no additional external cables are required and the sensor does not have to determine any accurate absolute values.

As, however, the first acquisition device can only supply information about a relative movement of the wheel 5, additional information is required, by means of which also the actual, absolute position of the wheel 5 can be determined. For this purpose a second acquisition device is provided, which has an indicator 17 and a detector 18. The indicator 17 is fixed on the chain 11 so that it stands opposite to the detector 18, when the wheel 5 is in its neutral or straight ahead position. When the indicator 17 is placed opposite to the detector 18, the detector 18 sends a reference signal to the control device 14, which can then balance the steering drive 4, that is, on the basis of this information and by means of the information about the relative movement the control device 14 can determine the absolute position of the wheel 5. In this connection it is not necessary for the indicator 17 to stay opposite to the detector 18. For practical reasons, this is not always possible during operation anyway. It is sufficient when a new setting or recorrection of the steering drive 4 is effected every time the indicator 17 passes the detector 18, which happens, for example, on steering movements exceeding the neutral position. Thus, faults occurring through the slip in the motor 6 can also be corrected continuously.

As it must be assumed that during operation of the vehicle the neutral position or the straight ahead position of the wheel 5 are effected rather often, a new setting or balancing of the steering drive 4 will take place just as often, meaning that in spite of the insufficient information about a relative movement there is still sufficient total information available about the position of the wheel 5. This can be obtained without having to use absolute sensors near the wheel 5. On the contrary, sensors which are practically arranged in or on the steering drive 4 will be sufficient.

With this embodiment a series of functions can be realised. For example, the steering angle indicator may have an additional arrangement 19, here an operating button. As soon as the driver presses the operating button 19, the control device 14 sets the wheel 5 in the straight ahead position.

The speed with which the wheel 5 is turned can also be made dependent on the operation speed of the steering angle indicator 2. If, for instance, the steering angle indicator is operated slowly, this results in a correspondingly slow steering of the wheel 5 with a high resolution, that is, a high accuracy. If, however, the steering column 3 is moved rapidly, this results in a faster steering of the wheel 5 with a lower resolution or accuracy. In the same way the steering speed of the wheel can be made dependent on the vehicle speed.

Additionally, the following functions can be realised with the presented steering arrangement 1: The steering angle of the wheel 5, that is, the angle area in which the wheel 5 can move, is of course limited. On steering movements to the right and to the left the wheel 5 will then hit mechanical stops. The resulting impact can be damaging for the operation, as it may cause heavy shocks on the vehicle. When the steering arrangement is, for instance, used with a fork truck, this may cause that goods stacked on a pallet may start sliding.

To prevent this, the steered wheel 5 is steered to both sides to hit the mechanical stops, and the control device 14 registers these stops. This registration may consist in the control device 14 monitoring the current led to the motor 6. As soon as a mechanical stop is reached, this current increases. Hitting the mechanical stops can be effected on order from the driver, automatically at the beginning of the operation or during operation, taking into consideration that each stop will only be hit once. The control device 14 will then “memorise” the angle positions of the stops and during the future operation it will prevent the wheel 5 from being turned to these positions, that is, the angle area, in which the wheel 5 moves, has a corresponding distance to the mechanical stops. As this function is self-teaching, a pre-setting of an angle limitation is not required. This simplifies mounting and maintenance of vehicles, which are provided with such steering arrangements.

1. Steering arrangement with a steering angle indicator, a steering drive, at least one wheel driven by the steering drive, a sensor arrangement sensing the angle position of the wheel and a control device, characterised in that the sensor arrangement has a first acquisition device (15, 16) sensing the extent of a movement of the steering drive (4) relative to a starting position and being integrated in the steering drive (4), and a second acquisition device (17, 18) producing a reference signal for at least one position of the steering drive (4).

2. Steering arrangement according to claim 1, characterised in that the second acquisition device (17, 18) has an indicator (17) arranged at a transmission element (11) of the steering drive (4) and a detector (18) co-operating with the indicator (17).

3. Steering arrangement according to claim 2, characterised in that the transmission element (11) is a chain, a toothed belt or a toothed gear.

4. Steering arrangement according to one of the claims 1 to 3, characterised in that the steering drive (4) has a rotary motor (6) and the first acquisition device (15, 16) senses a rotation angle of the motor (6).

5. Steering arrangement according to claim 4, characterised in that the first acquisition device (15, 16) senses the number of revolutions of the motor (6).

6. Steering arrangement according to claim 5, characterised in that the steering drive (4) has a transmission gear (8) and the sensor arrangement has a calculation device multiplying the number of revolutions of the motor by a value depending on the gear (8) transmission ratio.

7. Steering arrangement according to one of the claims 4 to 6, characterised in that the first acquisition device has a sensor built into a motor bearing.

8. Steering arrangement according to one of the claims 4 to 7, characterised in that the motor is an a.c. or a three-phase motor supplied by a frequency converter, the first acquisition device evaluating the supply voltage of the motor (6).

9. Steering arrangement according to claim 8, characterised in that the first acquisition device counts impulses supplied to the motor (6) by the frequency converter.

10. Steering arrangement according to one of the claims 1 to 9, characterised in that the control device (14) has a transmission characteristic, which depends on the operation speed of the steering angle indicator (2).

11. Steering arrangement according to one of the claims 1 to 10, characterised in that the control device has a transmission characteristic which depends on the driving speed of the steered vehicle.

12. Steering arrangement according to one of the claims 1 to 11, characterised in that the control device (14) has a straight ahead function.

13. Steering arrangement according to one of the claims 1 to 12, characterised in that the steering angle indicator (2) has a reset drive.

14. Steering arrangement according to one of the claims 1 to 13, characterized in that the control device (14) has an end stop monitoring arrangement sensing the end position of the steered wheel (5), and a limiter limiting the movements of the wheel (5) to a predetermined angle range ending at a certain distance from the end positions.

15. Steering arrangement according to claim 14, characterised in that the end stop monitoring arrangement monitors the motor current.

16. Steering arrangement according to one of the claims 1 to 15, characterised in that a starting signal or the putting into operation will make the control device (14) move the steered wheel (5) for so long that the second acquisition device (17, 18) emits a sensing signal.

17. Steering arrangement according to claim 16, characterised in that the control device moves the steered wheel (5) in both directions until stop.

18. Steering arrangement according to one of the claims 1 to 17, characterised in that the second acquisition device produces the reference signal in the area of the straight ahead position of the wheel (5).
